(19) United States
(12) Patent Application Publication
(10) Pub. No.: US 2020/0101954 A1
(43) Pub. Date: Apr. 2, 2020

(54) Braking System for Three Wheel Vehicles

(71) Applicant: Ronald A. Holland, Carlsbad, CA (US)

(72) Inventor: Ronald A. Holland, Carlsbad, CA (US)

(21) Appl. No.: 16/590,343

(22) Filed: Oct. 1, 2019

Related U.S. Application Data
(60) Provisional application No. 62/740,309, filed on Oct. 2, 2018.

(51) Int. Cl. B60T 8/1766; B60T 1/06; B62K 5/02; B62M 25/02; F16D 65/28

(52) U.S. Cl. CPC B60T 8/1766; B60T 1/065; B60T 1/067; F16D 2125/20; B62M 25/02; F16D 65/28; B62K 5/02

(57) ABSTRACT

A simple and inexpensive power brake system for a three-wheel vehicle with two wheels in the rear. One embodiment of the present invention allows the backing plate of a drum brake to rotate about twenty degrees on the axle of the front wheel that is attached to a brake drum, or a backing plate of a caliper of a disk brake to rotate about twenty degrees on the axle of the front wheel that is attached to a brake disk. Rotation of the backing plate is coupled to actuate the rear brake(s).

### CROSS-REFERENCE TO RELATED APPLICATIONS

The present application claims the priority of U.S. Provisional Patent Application Ser. No. 62/740,309 filed Oct. 2, 2018, which application is incorporated in its entirety herein by reference.

### BACKGROUND OF THE INVENTION

The present invention relates in general to three-wheel vehicles with a single wheel in the front, and more particularly to an improved braking system that uses motion of the front brake created by braking torque on the front wheel to amplify the braking force on the rear wheels.

To create the most dynamically stable three-wheel vehicle with a single wheel in the front, the center of gravity in either the loaded or unloaded condition must be as low as practically possible and slightly in front of the rear axle. This causes most of the weight to be concentrated on the two rear wheels with only a small amount of weight transfer to the front wheel during braking. Therefore, the braking force on the front wheel should be much smaller than braking torque on either of the two rear wheels. It is often difficult to properly manually balance the front and rear brakes.

### BRIEF SUMMARY OF THE INVENTION

The present invention addresses the above and other needs by providing a very simple and inexpensive power brake system for a three-wheel vehicle with two wheels in the rear. One embodiment of the present invention allows the backing plate of a drum brake to rotate about twenty degrees on the axle of the front wheel that is attached to a brake drum, or a backing plate of a caliper of a disk brake to rotate about twenty degrees on the axle of the front wheel that is attached to a brake disk. Rotation of the backing plate is coupled to actuate the rear brake(s).

In accordance with one aspect of the invention, there is provided a power brake system having one end of a cable attached to the rotatable backing plate and the other end to the brake actuator for the rear wheels. When the front wheel brake is applied the high torque from stopping the vehicle rotates the backing plate which pulls the cable that actuates the rear brakes. With the correct linkage the pad actuator on a drum brake can also be made to pull the cable for the rear brakes.

In accordance with another aspect of the invention, there is provided a power brake system having a caliper on a disk brake which may be used to pull a cable which actuates the rear brakes.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a diagrammatic partial side view of the front wheel and fork of a three-wheel vehicle with one embodiment of the present invention installed, but the brake is not activated.

FIG. 2 is similar to FIG. 1 except that the wheel is rotating and the brake is fully activated.

FIG. 3 shows a disk brake according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement, or indicates a measurement may be with 10% of the value stated.

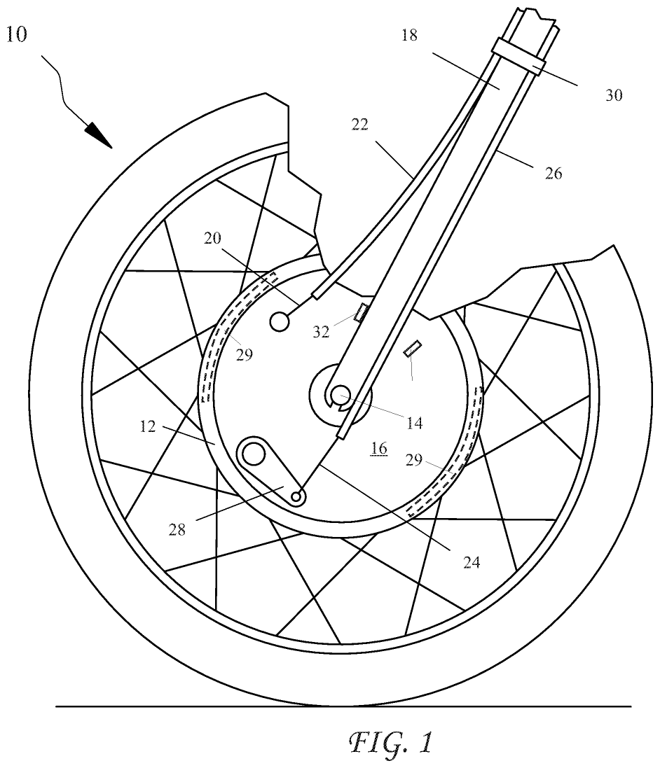

FIG. 1 is a diagrammatic partial side view of the front wheel 10, fork 18 and brake backing plate 16 of a three-wheel vehicle (not shown) with the means for braking the rear wheels. Brake drum 12 of wheel 10 rotates on axle 14 which is fixedly mounted to the bottom of fork 18. The backing plate 16 is also able to rotate on axle 14, but only a total of about twenty degrees. The backing plate 16 supports brake shoes on a back side (not shown) and a brake actuation lever 28 on the front side pressing brake pads 29 out against the brake drum 12.

A rear brake actuator comprising a cable 20 is attached to the backing plate 16 at a point offset from the axle 14 in a direction ahead of the fork 18, and on the other end to the means for braking the rear wheels (not shown). A front brake able 24 is rotatably mounted on one end to the brake actuation lever 28 and on the other end to a prior art hand operated brake lever on the handle bars (not shown). In FIG. 1 brake lever 28 is not in the braking position therefore wheel 10 is able to rotate freely. Brake cable shields 22 and 26 are fixedly mounted to fork 18 by clamp 30. A stop 32 may be included to limit clockwise rotation of the backing plate 16 when tension on the cable 20 urges the backing plate 16 in the clockwise direction to position the stop 32 against the fork 18 when braking in not active. A second stop 33 may be included to limit the counter-clockwise rotation of the backing plate when the front brake is applied. The combination of the stops 32 and 33 preferably limits rotation of the backing plate to between 15 and 25 degrees, and more preferably to about 20 degrees.

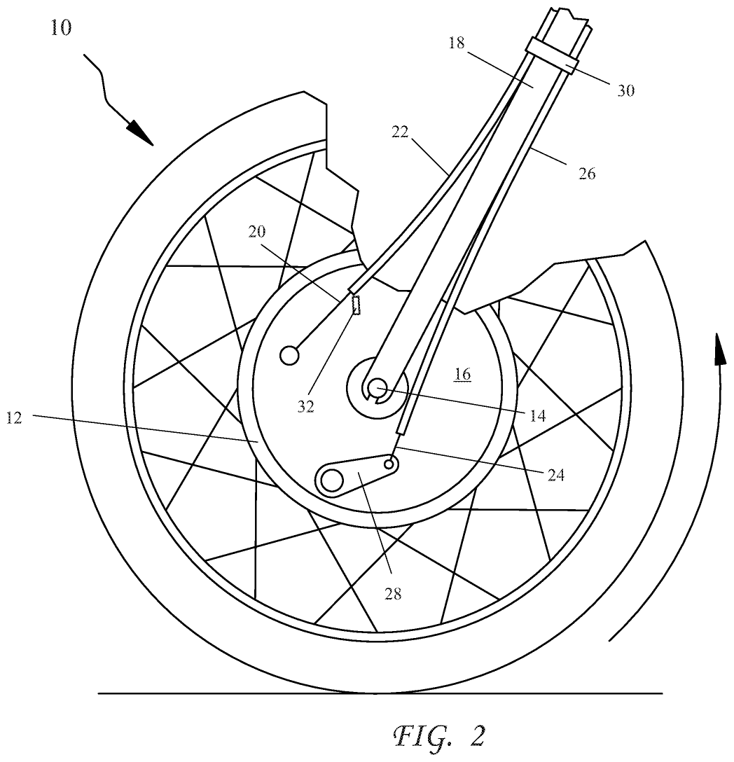

FIG. 2 is the same as FIG. 1 except that wheel 10 is rolling forward and brake lever 28 is being pulled tightly by cable 24 fully activating the front brake which causes wheel 10 to rotate backing plate 16 and pull cable 20 hard and far enough to fully activate the rear brakes. The same end could be achieved by using hydraulics instead of cables. This method of using the energy and force from stopping the vehicle to apply the rear brakes greatly reduces the effort required by the operator and better controls the ratio of braking front to back on a three-wheel vehicle with two wheels on the rear.

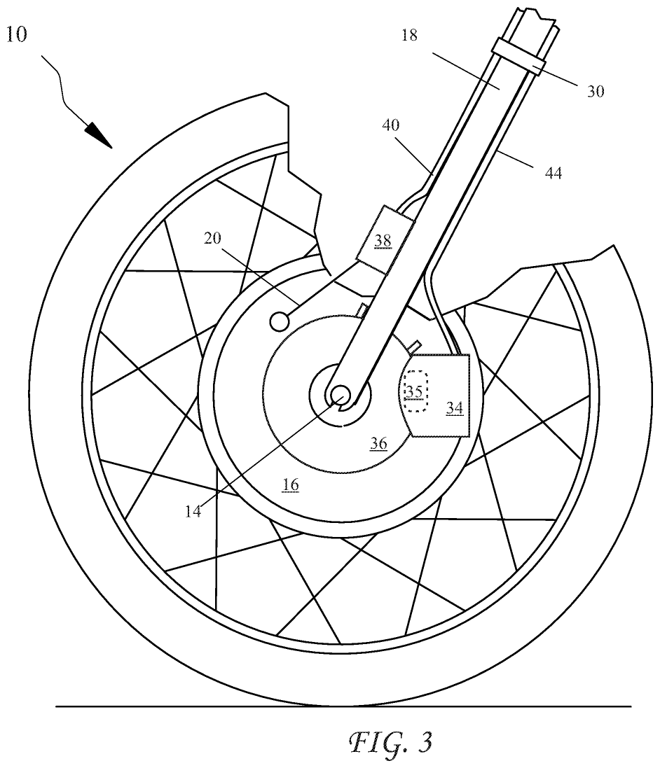

The invention exercised with a front disk brake is shown in FIG. 3, the brake caliper 34 actuated through hydraulic line 44 is attached to the rotatable caliper bracket 16, to press brake pads 35 against the brake disk 36. The cable 20 is attached to the rotatable caliper bracket at a point offset from the axle 14 in a direction ahead of the fork 18, and the cable 20 actuates a rear brake actuator comprising a rear brake master cylinder 38 connected to a rear brake hydraulic line 40. The caliper 34 and/or rear brake may alternatively be actuated by cables.

While the invention herein disclosed has been described by means of specific embodiments and applications thereof, numerous modifications and variations could be made thereto by those skilled in the art without departing from the scope of the invention set forth in the claims.

I claim:

1. A method for applying braking, comprising:
applying a front brake;
actuating brake shoes of a drum brake or a brake caliper of a disk brake, the drum brake or the brake caliper coupled to rotate with a rotatable backing plate;
contact of the brake shoes with a brake drum, or brake pads with a brake disk, creating a braking torque;
transferring the braking torque to a front wheel to provide braking;
transferring the braking torque to the backing plate to rotate the backing plate; and
rotation of the backing plate actuating a rear brake actuator.

2. The method of claim 1, wherein:
actuating the brake shoes of the drum brake or the brake caliper of the disk brake, comprises actuating the brake shoes of the drum brake; and
rotation of the backing plate actuating the rear brake actuator comprises rotation of the backing plate pulling a rear brake cable actuator.

3. The method of claim 1, wherein:
actuating the brake shoes of the drum brake or the brake caliper of the disk brake, comprises actuating the brake caliper of the disk brake; and
rotation of the backing plate actuating the rear brake actuator comprises rotation of the backing plate actuating a rear brake master cylinder.

4. The method of claim 1, wherein transferring rotation of the backing plate to actuating the rear brake actuator comprises transferring an actuation proportional to an amount of braking of the front wheel of a three wheel vehicle, to the rear brake actuator.

5. The method of claim 1, wherein stops limit rotation of the backing plate to about 20 degrees.

6. A rear brake actuator for a three wheel vehicle, comprising:
a rotatable front brake backing plate;
brake shoes of a front drum brake or a brake caliper of a front disk brake attached to the backing plate;
a rear brake actuator fixed with respect to a front wheel axle and coupled to a rear brake to actuate the rear brake;
a link between the backing plate and the rear brake actuator,
an attachment point of the link to the backing plate; and
wherein rotation of the backing plate corresponding to rotation of a front wheel to a second position increases separation of the attachment point from the rear brake actuator.

7. The rear brake actuator of claim, wherein the front drum brake or the front disk brake is a front drum brake.

8. The rear brake actuator of claim 6, wherein the front drum brake or the front disk brake is a front disk brake.

9. The method of claim 6, wherein stops limit rotation of the backing plate to about 20 degrees.

10. A rear brake actuator for a three wheel vehicle, comprising:
a rotatable front brake backing plate;
brake shoes of a front drum brake or a brake caliper of a front disk brake attached to the backing plate;
a rear brake actuator fixed with respect to a front wheel axle and coupled to a rear brake to actuate the rear brake;
a link between the backing plate and the rear brake actuator,
an attachment point of the link to the backing plate; and
stops limit rotation of the backing plate to 20 degrees,
wherein rotation of the backing plate corresponding to rotation of a front wheel to a second position increases separation of the attachment point from the rear brake actuator.
